(19) United States
(12) Patent Application Publication
(10) Pub. No.: US 2015/0095297 A1
(43) Pub. Date: Apr. 2, 2015

(54) METHOD AND SYSTEM FOR ACQUIRING AND ISSUING INSTRUCTION, TERMINAL, SERVER AND STORAGE MEDIUM

(71) Applicant: TENCENT TECHNOLOGY (SHENZHEN) COMPANY LIMITED, Shenzhen (CN)

(72) Inventors: Qing Wang, Shenzhen (CN); Haoran Guo, Shenzhen (CN); Quanhao Xiao, Shenzhen (CN); Yixia Yuan, Shenzhen (CN); Xunchang Zhan, Shenzhen (CN); Chunyou Lin, Shenzhen (CN); Pengtao Li, Shenzhen (CN); Jiashun Song, Shenzhen (CN)

(21) Appl. No.: 14/568,020

(22) Filed: Dec. 11, 2014

Related U.S. Application Data
(63) Continuation of application No. PCT/CN2013/077024, filed on Jun. 8, 2013.

(30) Foreign Application Priority Data
Jun. 26, 2012 (CN) 201210213176.6

(51) Int. Cl. G06F 17/30

(52) U.S. Cl. CPC G06F 17/30477; G06F 17/30309
USPC 707/695; 707/769

(57) ABSTRACT

A method and system for acquiring and issuing a query instruction, a mobile terminal, a server, an information interaction system and a computer storage medium are provided. In the method, a mobile terminal transmits to a server a SMS message for acquiring a query instruction set; and the mobile terminal receives a query instruction set issued by the server. According to the disclosure, the mobile terminal acquires a query instruction set consisting of query instructions for querying various service information from a server of an operator, a user does not have to remember any query instructions and only has to select services to be queried according to the query instruction set so that query instructions corresponding to the services to be queried can be automatically transmitted.

### CROSS REFERENCE TO RELATED APPLICATION

The present patent application is a U.S. continuation application under 35 U.S.C. §111(a) claiming priority under 35 U.S.C. §§120 and 365(c) to International Application No. PCT/CN2013/077024 filed on Jun. 8, 2013, which claims priority of the Chinese patent application No. 201210213176.6, entitled “METHOD AND SYSTEM FOR ACQUIRING AND ISSUING INSTRUCTION, TERMINAL, SERVER” and filed by applicant Tencent Technology (Shenzhen) Co., Ltd on Jun. 26, 2012, each of which is incorporated into the present application by reference in its entity.

### TECHNICAL FIELD

The disclosure relates to the field of communications, and in particular to a method and system for acquiring and issuing a query instruction, a mobile terminal, a server and a computer storage medium.

### BACKGROUND

In the prior art, to facilitate users to query various service information, an operator generally sets some common query instructions. A user may edit a short messaging service (SMS) message with a query content using his/her mobile phone and then send it to a specified number port. After receiving the SMS message, the operator may query the corresponding information and feed a query result back to the user in a form of an SMS message.

Though the above method greatly conveniences a user to query information and reduces the pressure for operators to deal with user queries manually, there are also some disadvantages. For example, as an operator provides more and more services, dozens of query instructions have been set, and it is hard for a user to remember the instructions corresponding to query services he/she desires to use. However, whenever the user desires to make a query, he/she has to input a query instruction, and it may be prone to input an incorrect query instruction if the user cannot remember the instruction clearly. Moreover, a message fee will be incurred each time a query instruction input through a mobile terminal is transmitted to a server, thereby resulting in unnecessary communication fees and bringing inconvenience to user operations.

### SUMMARY

According to various embodiments of the disclosure, a method and system for acquiring and issuing a query instruction, a mobile terminal and a server are provided, so that a user does not have to remember the instructions corresponding to the query services he/she desires to use, thus avoiding unnecessary communication fees incurred by an incorrect instruction that may be possibly input and inconveniences to user operations.

In an embodiment of the disclosure, a method for acquiring a query instruction is provided, which includes: transmitting, by a mobile terminal, a short messaging service (SMS) message for acquiring a query instruction set to a server; and receiving, by the mobile terminal, the query instruction set issued by the server.

In another embodiment of the disclosure, a system for acquiring a query instruction is provided, which includes: a short messaging service (SMS) message transmission module, configured to transmit a SMS message for acquiring a query instruction set to a server; and an instruction set reception module, configured to receive the query instruction set issued by the server.

In yet another embodiment of the disclosure, a mobile terminal is provided, which includes the aforementioned system for acquiring the query instruction.

In yet another embodiment of the disclosure, a method for issuing a query instruction is provided, which includes: receiving from a mobile terminal, by a server, a short messaging service (SMS) message for acquiring a query instruction set; and reading, by the server, a pre-stored query instruction set, and issuing the pre-stored query instruction set to the mobile terminal.

In yet another embodiment of the disclosure, a system for issuing a query instruction is provided, which includes: a short messaging service (SMS) message reception module, configured to receive a SMS message for acquiring a query instruction set from a mobile terminal; and an issuing module, configured to read a pre-stored query instruction set, and issue the pre-stored query instruction set to the mobile terminal.

In yet another embodiment of the disclosure, a server is provided, which includes the aforementioned system for issuing the query instruction.

In yet another embodiment of the disclosure, an information interaction system is provided, which includes the aforementioned mobile terminal and the aforementioned server.

In yet another embodiment of the disclosure, a computer storage medium, in which computer-executable instructions are stored, wherein the computer-executable instructions are configured to implement the aforementioned method for acquiring the query instruction and the aforementioned method for issuing the query instruction.

In the embodiments of the disclosure, a mobile terminal acquires a query instruction set consisting of query instructions for querying service information from a server of an operator, the query instructions being packed and sent to the mobile terminal. In this way, a user does not have to remember any specific query instructions. Instead, the user only has to select a query service he/she desires to use. Accordingly, the query instruction set may be searched for a query instruction corresponding to a name of the query service, and consequently, the query instruction corresponding to the query service can be automatically transmitted. With the subject matter of the disclosure, a user does not have to remember the instruction corresponding to the query service he/she desires to use, thus avoiding unnecessary communication fees incurred by an incorrect instruction that may be possibly input and inconveniences to user operations.

This section is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

These and other sample aspects of the disclosure will be described in the detailed description and the claims that follow, and in the accompanying drawings, wherein:

FIG. 1 is a flow chart of a method for acquiring a query instruction according to an embodiment of the disclosure;

FIG. 2 is a schematic diagram of a selection interface with check boxes and names of query services according to an embodiment of the disclosure;

FIG. 3 is a flow chart of a method for issuing a query instruction according to an embodiment of the disclosure;

FIG. 4 is a block diagram of a system for acquiring a query instruction according to an embodiment of the disclosure; and

FIG. 5 is a block diagram of a system for issuing a query instruction according to an embodiment of the disclosure.

FIG. 6 is a flow chart of a method for acquiring a query instruction according to an embodiment of the disclosure;

FIG. 7 is a structure schematic view illustrating a system for acquiring a query instruction as shown in FIG. 3;

FIG. 8 is a structure schematic view illustrating a system for acquiring a query instruction as shown in FIG. 5; and

FIG. 9 illustrates a structure schematic view of a system for implementing a query service.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

In order to make subject matter and beneficial effects of the disclosure more clear, the disclosure will be further elaborated below in combination with the accompanying drawings and embodiments. It should be understood that the specific embodiments are only used to interpret the disclosure, rather than limiting the disclosure.

It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. Furthermore, an aspect may comprise at least one element of a claim.

The term “mobile terminal” used herein may take any suitable physical form. For example, it may also be referred to as a mobile device, a mobile station, a mobile phone, a user terminal, a user equipment (UE), a personal digital assistant (PDA), a tablet personal computer, a handheld device having wireless connection capability, a vehicle intelligent terminal, or any other processing devices connected to a wireless modem.

According to various embodiments of the disclosure, the mobile terminal acquires query instructions for querying various service information from a server of an operator. In this way, a user does not have to remember any query instruction. Instead, the user only has to select query service(s) to be used, and one or more query instructions corresponding to the selected query service(s) can be automatically transmitted. Accordingly, a user does not have to remember the instruction corresponding to the query service he/she desires to use, thus avoiding unnecessary communication fees incurred by an incorrect instruction that may be possibly input and inconveniences to user operations.

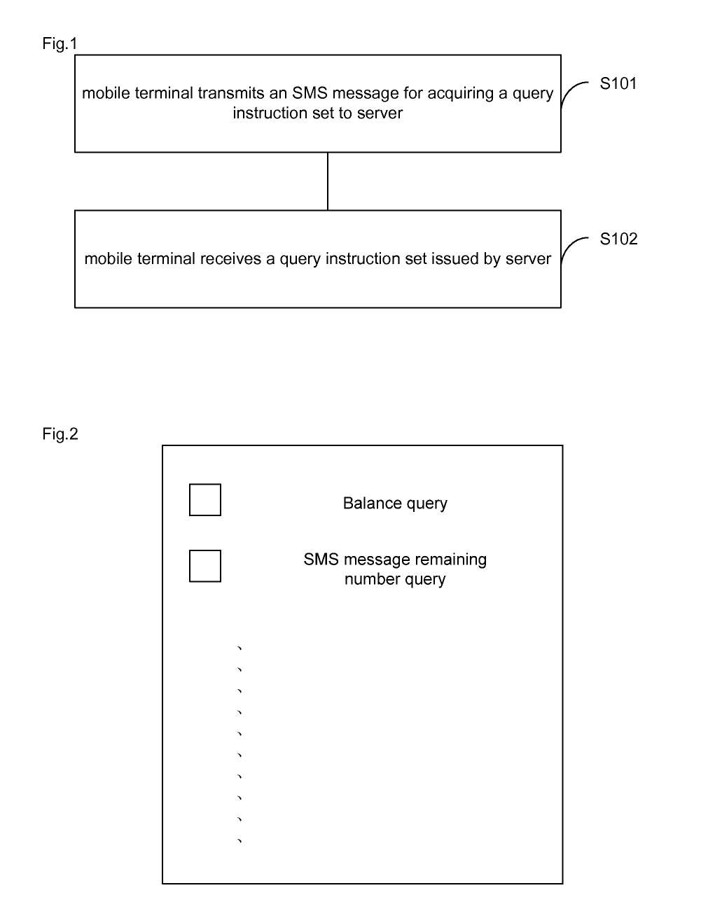

FIG. 1 is a flow chart of a method for acquiring a query instruction according to an embodiment of the disclosure. Referring to FIG. 1, the method includes the following steps.

At step S101, a mobile terminal transmits an SMS message for acquiring a query instruction set to a server.

In an embodiment of the disclosure, the query instruction set mainly includes names of query services, query instructions corresponding to the names of the query services, and receiving number ports corresponding to the names of the query services.

In a preferable embodiment of the disclosure, when a mobile terminal has a function for querying phone number attribution, the SMS message may further include attribution information associated with a phone number of the mobile terminal, so as to facilitate a server to look for a query instruction set associated with the attribution information.

At step S102, the mobile terminal receives a query instruction set issued by the server.

After step S102, the following steps may also be performed, as shown in FIG. 6.

At step S103, a name of the query service desired to be used is received. The name is selected at a client.

At step S104, the mobile terminal searches the query instruction set for a query instruction corresponding to the name of the query service.

At step S105, the mobile terminal automatically transmits the searched out query instruction to an operator specified number port.

In an embodiment of the disclosure, in order to acquire a latest query instruction set, the method further includes the following step: the mobile terminal transmits periodically the SMS message for acquiring the query instruction set to the server, wherein the SMS message further includes a version number of the query instruction set currently owned by the mobile terminal.

In another embodiment of the disclosure, in order to facilitate the user of the mobile terminal to select a query service he/she desires to use, the method further includes the following step: the mobile terminal generates a selection interface with check boxes and names of query services according to the query instruction set, as shown in FIG. 2.

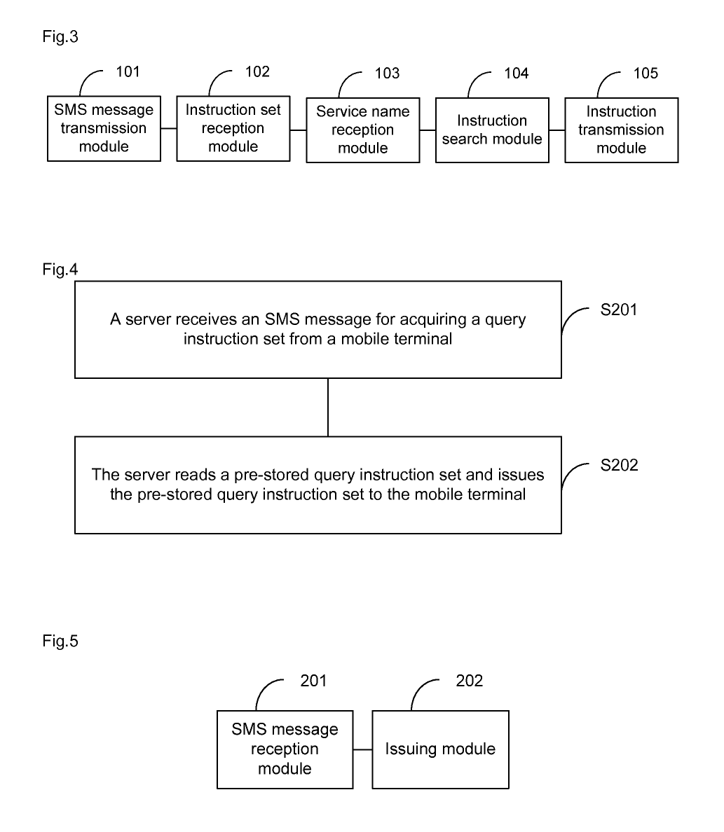

FIG. 3 is a flow chart of a method for issuing a query instruction according to an embodiment of the disclosure. Referring to FIG. 3, the method includes the following steps.

At step S201, a server receives from a mobile terminal a short messaging service (SMS) message for acquiring a query instruction set.

At step S202, the server reads a pre-stored query instruction set, and issues the pre-stored query instruction set to the mobile terminal.

In an embodiment of the disclosure, after step S201, the method further includes the following step: the server determines whether attribution information associated with the phone number of the mobile terminal is included in the SMS message; if yes, the server searches for a query instruction set associated with the attribution information; if no, the server acquires the attribution information associated with the phone number of the mobile terminal by matching.

In another embodiment of the disclosure, in order to ensure that the instruction set acquired by the mobile terminal is a latest one, the method further includes the following steps: the server receives an SMS message including a version number of the query instruction set currently owned by the mobile terminal from the mobile terminal; and the server compares the received version number with a version number of a latest query instruction set at the server; if the version number of the latest query instruction set is higher than the received version number, the server issues the latest query instruction set to the mobile terminal.

FIG. 4 is a block diagram of a system for acquiring a query instruction according to an embodiment of the disclosure. Referring to FIG. 4, for the sake of description, only portions associated with the embodiment of the disclosure are shown. The system for acquiring a query instruction can be a software unit, a hardware unit or a combination thereof built in the mobile terminal.

The system for acquiring a query instruction includes a SMS message transmission module 101, an instruction set reception module 102, a service name reception module 103, an instruction searching module 104 and an instruction transmission module 105.

The SMS message transmission module 101 is configured to transmit an SMS message for acquiring a query instruction set to a server.

In an embodiment of the disclosure, the query instruction set mainly includes names of query services, query instructions corresponding to the names of the query services, and receiving number ports corresponding to the names of the query services.

In a preferable embodiment of the disclosure, when a mobile terminal has a function for querying phone number attribution, the SMS message may further include attribution information associated with a phone number of the mobile terminal, so as to facilitate a server to search for a query instruction set associated with the attribution information.

The instruction set reception module 102 is configured to receive a query instruction set issued by the server.

The service name reception module 103 is configured to receive a name of a query service desired to be used, the name being selected at a client.

The instruction search module 104 is configured to search the query instruction set for a query instruction corresponding to the name of the query service.

The instruction transmission module 105 is configured to transmit automatically the searched out query instruction to an operator specified number port.

In an embodiment of the disclosure, in order to acquire a latest query instruction set, the system further includes a periodical transmission module, configured to transmit periodically the SMS message for acquiring the query instruction set to the server, wherein the SMS message includes a version number of the query instruction set currently owned by the mobile terminal.

In another embodiment of the disclosure, in order to facilitate a user of a mobile terminal to select a query service to be used, the system further includes an interface generation module, configured to generate a selection interface with check boxes and names of query services according to the query instruction set.

FIG. 5 is a block diagram of a system for issuing a query instruction according to an embodiment of the disclosure. Referring to FIG. 5, for the sake of description, only portions associated with the embodiment of the disclosure are shown. The system for issuing a query instruction can be a software unit, a hardware unit or a combination thereof built in a server.

The system for issuing a query instruction includes a SMS message reception module 201 and an issuing module 202.

The SMS message reception module 201 is configured to receive a SMS message for acquiring a query instruction set from a mobile terminal.

The issuing module 202 is configured to read a pre-stored query instruction set, and issue the pre-stored query instruction set to the mobile terminal.

In an embodiment of the disclosure, the system further includes a determination module, a search module, and a match module.

The determination module is configured to determine whether attribution information associated with a phone number of the mobile terminal is included in the SMS message.

The search module is configured to search for a query instruction set associated with the attribution information, when it is determined that the attribution information associated with the phone number of the mobile terminal is included in the SMS message.

The match module is configured to acquire the attribution information associated with the phone number of the mobile terminal by matching, when it is determined that the attribution information associated with the phone number of the mobile terminal is not included in the SMS message.

In an embodiment of the disclosure, in order to ensure that the instruction set acquired by the mobile terminal is of a latest one, the system further includes a version number reception module and a comparison module.

The version number reception module is configured to receive a SMS message including a version number of the query instruction set currently owned by the mobile terminal from the mobile terminal.

The comparison module is configured to compare the received version number with the version number of a latest query instruction set at the terminal.

Moreover, the issuing module is further configured to issue the latest query instruction set to the mobile terminal, if the version number of the latest query instruction set is higher than the received version number.

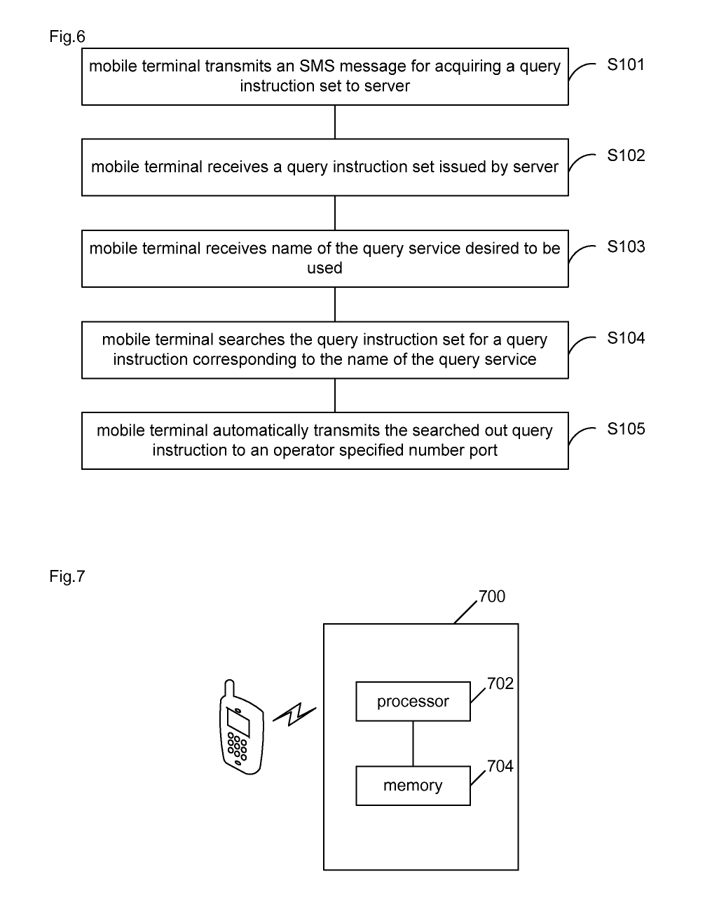

FIG. 7 is a structure schematic view illustrating a system for acquiring a query instruction as shown in FIG. 3.

Herein, the system for acquiring a query instruction is implemented as a mobile terminal 700. In an embodiment, software running on the mobile terminal performs one or more steps of the method as described referring to FIG. 1 or 6 or implements functions of the various modules or units as described referring to FIG. 3.

In an embodiment, the mobile terminal 700 includes a processor 702 and a memory 704. Although this disclosure describes and illustrates a particular mobile terminal having a particular number of particular components in a particular arrangement, any suitable mobile devices having any suitable number of any suitable components can be contemplated.

In an embodiment, the processor 702 includes hardware for executing instructions, for example, one or more computer programs. The processor 702 may retrieve instructions from the memory 704 and execute them.

In an embodiment, the memory 704 may store instructions for the processor 702 to execute or data for the processor 702 to operate on. In an embodiment, the memory 704 may include random access memory (RAM), which may be dynamic RAM (DRAM) or static RAM (SRAM) as desired.

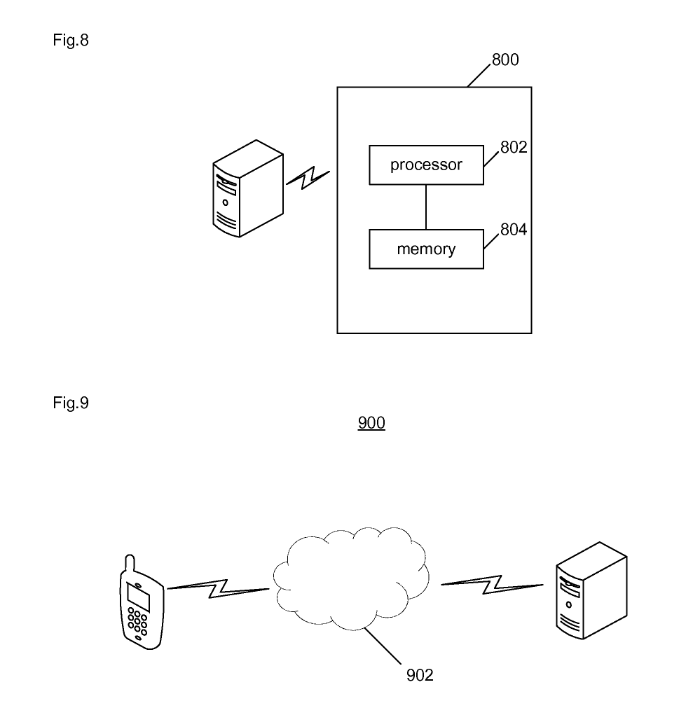

FIG. 8 is a structure schematic view illustrating a system for issuing a query instruction as shown in FIG. 5.

Herein, the system for acquiring a query instruction is implemented as a server 800. In an embodiment, software running on the server performs one or more steps of the method as described referring to FIG. 4 or implements functions of the various modules or units as described referring to FIG. 5.

In an embodiment, the processor 802 includes hardware for executing instructions, for example, one or more computer programs. The processor 802 may retrieve instructions from the memory 804 and execute them. The processor 802 may be implemented as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform one or more of the method steps as described referring to FIG. 4 or to implement the various modules as described referring to FIG. 5.

In an embodiment, the memory 804 may store instructions for the processor 802 to execute or data for the processor 802 to operate on. In an embodiment, the memory 804 may include random access memory (RAM), which may be dynamic RAM (DRAM) or static RAM (SRAM) as desired. Additionally, the memory 404 may include storage for storing data and instructions, such as read-only memory (ROM), such as mask-programmed ROM, programmable ROM (PROM), erasable PROM (EPROM), electrically erasable PROM (EEPROM), electrically alterable ROM (EAROM), or flash memory. In an embodiment, the storage may be internal or external to the server 800. In an embodiment, the storage stores instructions for performing one or more of the method steps as described referring to FIG. 4 or for implementing the various modules as described referring to FIG. 5. The query instruction set acquired by the mobile terminal may also be located in this storage, or may be located in a storage locally connected to this storage, or may be located in a storage remote to this storage. As an example and not by way limitation, the server 800 may load instructions from the storage or other sources (for example, remote sources) to the RAM, and then the processor 802 may retrieve the instructions from the RAM to execute them. In an embodiment, the memory 804 may include one or more memories.

FIG. 9 illustrates a structure schematic view of a system for implementing query services. As shown in FIG. 9, the system includes a mobile terminal 700 and a server 800, which may be connected to each other through a network 902.

In an embodiment, the mobile terminal 700 transmits an SMS message for acquiring a query instruction set to the server 800; upon reception of the SMS message, the server 800 reads a pre-stored query instruction set, and issues the pre-stored query instruction set to the mobile terminal 700; the mobile terminal 700 receives the query instruction set issued by the server 800, so that a user does not have to directly input the query instruction he/she desires to use.

In an embodiment, the mobile terminal and the server communicate with each other using SMS messages, and accordingly, the network 902 is a mobile communication network. However, as appreciated in the art, the mobile terminal and the server may communicate with each other by other means, and the network 902 may be, for example, a personal area network (PAN), a local area network (LAN), a wide area network (WAN), a WIFI network, etc.

To sum up, according to various embodiments of the disclosure, the mobile terminal acquires query instructions for querying various service information from a server of an operator. In this way, a user does not have to remember any query instruction. Instead, the user only has to select query service(s) to be used, and consequently, one or more query instructions corresponding to the selected query service(s) can be automatically transmitted.

If an integrated module according to embodiments of the disclosure is implemented in a form of a software functional module and sold or used as an independent product, it may also be stored in a computer-readable storage medium. Based on such an understanding, the technical solutions according to embodiments of the disclosure in essence or the part contributing to the prior art can be embodied in the form of a software product, and the computer software product is stored in a storage medium, which includes several instructions so that a computer device (e.g., personal computer, server, network device or the like) implements all or part of the method according to embodiments of the disclosure. The aforementioned storage medium includes various media capable of storing a program code such as a USB disk, a mobile hard drive disk, a Read-Only Memory (ROM), a Random Access Memory (RAM), a magnetic disk or an optical disk. In this way, the embodiments of the disclosure are not limited to any specific combination of hardware and software.

Accordingly, an embodiment of the disclosure further provides a computer storage medium, in which computer-executable instructions are stored, wherein the computer-executable instruction is configured to implement the method for acquiring the query instruction and the method for issuing the query instruction according to embodiments of the disclosure.

The above descriptions are merely preferable embodiments of the disclosure, and are not intended to limit the disclosure. All modifications, replacements and improvements made within the spirit and principles of the disclosure should be included within the scope of protection of the disclosure.

1. A method for acquiring a query instruction, comprising:
transmitting, by a mobile terminal, message for acquiring a query instruction set to a server; and
receiving, by the mobile terminal, the query instruction set issued by the server.

2. The method according to claim 1, further comprising: after receiving the query instruction set issued by the server,
receiving, by the mobile terminal, a name of a query service desired to be used;
searching, by the mobile terminal, the query instruction set for a query instruction corresponding to the name of the query service; and
transmitting automatically, by the mobile terminal, the searched out query instruction to an operator specified number port.

3. The method according to claim 1, further comprising:
transmitting periodically, by the mobile terminal, the message for acquiring the query instruction set to the server,
wherein the message for acquiring the query instruction set further contains a version number of the query instruction set currently owned by the mobile terminal.

4. The method according to claim 1, further comprising:
generating, by the mobile terminal, a selection interface with check boxes and names of query services according to the query instruction set, and
wherein the name of the query service desired to be used is selected at the selection interface.

5-8. (canceled)

9. A mobile terminal, comprising:
a processor; and
a memory, coupled to the processor, and comprising instructions that, when executed, cause the processor to:
transmit a short messaging service (SMS) message for acquiring a query instruction set to a server; and
receive the query instruction set issued by the server.

10. A method for issuing a query instruction, comprising:
receiving from a mobile terminal, by a server, a short messaging service (SMS) message for acquiring a query instruction set;
reading, by the server, a pre-stored query instruction set; and
issuing, by the server, the pre-stored query instruction set to the mobile terminal.

11. The method according to claim 10, further comprising:
after receiving the message for acquiring the query instruction set from the mobile terminal,
determining, by the server, whether attribution information associated with a phone number of the mobile terminal is included in the message;
if yes, searching for the query instruction set associated with the attribution information;
if no, acquiring, by the server, the attribution information associated with the phone number of the mobile terminal by matching.

12. The method according to claim 10, further comprising:
receiving, by the server, the message including a version number of the query instruction set currently owned by the mobile terminal from the mobile terminal;
comparing, by the server, the received version number with a version number of a latest query instruction set at the server; and
issuing, by the server, the latest query instruction set to the mobile terminal, if the version number of the latest query instruction set is higher than the received version number.

13-15. (canceled)

16. A server, comprising:
a processor; and
a memory, coupled to the processor, and comprising instructions that, when executed, cause the processor to:
receive from a mobile terminal a short messaging service (SMS) message for acquiring a query instruction set;
read a pre-stored query instruction set; and
issue the pre-stored query instruction set to the mobile terminal.

17. An information interaction system, comprising a mobile terminal and a server,
wherein the mobile terminal is configured to:
transmit a short messaging service (SMS) message for acquiring a query instruction set to a server; and
receive the query instruction set issued by the server, and
wherein the server is configured to:
receive from a mobile terminal a short messaging service (SMS) message for acquiring a query instruction set;
read a pre-stored query instruction set; and
issue the pre-stored query instruction set to the mobile terminal.

18. (canceled)

19. The mobile terminal according to claim 9, wherein the memory further comprises instructions that, when executed, cause the processor to: after receiving the query instruction set issued by the server,
receive a name of a query service desired to be used;
search the query instruction set for a query instruction corresponding to the name of the query service; and
transmit automatically the searched out query instruction to an operator specified number port.

20. The mobile terminal according to claim 9, wherein the memory further comprises instructions that, when executed, cause the processor to transmit periodically the message for acquiring the query instruction set to the server,
wherein the message for acquiring the query instruction set further contains a version number of the query instruction set currently owned by the mobile terminal.

21. The mobile terminal according to claim 9, wherein the memory further comprises instructions that, when executed, cause the processor to generate a selection interface with check boxes and names of query services according to the query instruction set,
wherein the name of the query service desired to be used is selected at the selection interface.

22. The server according to claim 16, wherein the memory further comprises instructions that, when executed, cause the processor to: after receiving the message for acquiring the query instruction set from the mobile terminal,
determine whether attribution information associated with a phone number of the mobile terminal is included in the message;
if yes, search for the query instruction set associated with the attribution information;
if no, acquire the attribution information associated with the phone number of the mobile terminal by matching.

23. The server according to claim 16, wherein the memory further comprises instructions that, when executed, cause the processor to: after receiving the message for acquiring the query instruction set from the mobile terminal,
receive the message including a version number of the query instruction set currently owned by the mobile terminal from the mobile terminal;
compare the received version number with a version number of a latest query instruction set at the server; and
issue the latest query instruction set to the mobile terminal, if the version number of the latest query instruction set is higher than the received version number.

24. The system according to claim 17, wherein the mobile terminal is further configured to: after receiving the query instruction set issued by the server,
receive a name of a query service desired to be used;
search the query instruction set for a query instruction corresponding to the name of the query service; and
transmit automatically the searched out query instruction to an operator specified number port.

25. The system according to claim 17, wherein the mobile terminal is further configured to transmit periodically, by the mobile terminal, the message for acquiring the query instruction set to the server,
wherein the message for acquiring the query instruction set further contains a version number of the query instruction set currently owned by the mobile terminal.

26. The system according to claim 17, wherein the mobile terminal is further configured to generate a selection interface with check boxes and names of query services according to the query instruction set,
wherein the name of the query service desired to be used is selected at the selection interface.

27. The system according to claim 17, wherein the server is further configured to: after receiving the message for acquiring the query instruction set from the mobile terminal,
determine whether attribution information associated with a phone number of the mobile terminal is included in the message;
if yes, search for a query instruction set associated with the attribution information;
if no, acquire the attribution information associated with the phone number of the mobile terminal by matching.

28. The system according to claim 17, wherein the server is further configured to: after receiving the message for acquiring the query instruction set from the mobile terminal,
receive the message including a version number of the query instruction set currently owned by the mobile terminal from the mobile terminal;
compare the received version number with a version number of a latest query instruction set at the server; and
issue the latest query instruction set to the mobile terminal, if the version number of the latest query instruction set is higher than the received version number.
